(19) United States
(12) Patent Application Publication
(10) Pub. No.: US 2003/0085362 A1
(43) Pub. Date: May 8, 2003

(54) Method and system for detection of an analytical chip plate

(76) Inventor: Valery Bogdanov, Lawrenceville, NJ (US)

Correspondence Address: Kevin G. Mierzwa, ARTZ & ARTZ, P.C., Suite 250, 28333 Telegraph, Southfield, MI, 48034, US

(21) Appl. No.: 10/004,335

(22) Filed: Nov. 2, 2001

(51) Int. Cl. G01N 21/64

(52) U.S. Cl. 250/458.1

(57) ABSTRACT

An analysis device for analyzing a plate having a first side and a second side comprises a plate holder for holding the plate and an excitation source positioned on the first side of the plate under the plate holder. The laser source generates an excitation beam through the plate. The excitation beam forms an imaging beam on the second side of the plate. An optical assembly is positioned on the second side of the plate and receives the imaging beam. A detector is disposed adjacent to the optical assembly and receives the imaging beam and forms an image of the plate therein.

### TECHNICAL FIELD

The present invention relates generally to light-based detection systems, and more particularly, to detection systems for detecting a reaction on an analytical chip plate.

### BACKGROUND

Methods of making a homologous series of compounds, or the testing of new potential drug compounds comprising a series of light compounds, has been a slow process because each member of a series or each potential drug must be made individually and tested individually. For example, a plurality of potential drug compounds that differ perhaps only by a single amino acid or nucleotide base, or a different sequence of amino acids or nucleotides are tested by an agent to determine their potential for being suitable drug candidates. Analytical chip plates may be used as holding devices to carry out the analysis.

Analytical chip plates may also be used for the direct sequencing of DNA by hybridization with arrays of oligonucleotides. Synthesis of arrays of bound oligonucleotides or peptides are known. The arrays of oligonucleotides may then be probed with target DNA.

An analytical chip plate is a device having a micro-array disposed at a plurality of sites such as wells. Typically, a plurality of arrays is formed on a chip plate for analysis. The arrays may comprise single nucleotide-polymorphisms (SNPs) or other genetic materials. In many applications, the chip plate dimensions have a well pattern that are identical to standard microtiter plates; for example, 96 wells, 384 wells, 586, etc. By providing standardized chips, automated robotic handling may be used for parallel processing of the plates for high throughput, fully automated processing of the reactions.

Commonly, a light source such as a fluorescent light source is used to illuminate the arrays. Typically, the illumination and detection takes place on the same side of the array. That is, illumination and detection from the top surface is common. Detection and illumination from the bottom is also known in a system using a transparent chip plate. One such system is disclosed in U.S. Pat. No. 5,545,531. A reaction is detected when one of the spots in the array fluoresces in the presence of an excitation light. Fluorescent labeling is a highly sensitive, analytical technique that minimizes the amount of probe reagents per reaction. Several drawbacks to fluorescent detection methodology are evident to those skilled in the art. Contamination of the fluorescent analytical signal with background fluorescence due to scattering or emissions by the chip plate itself may be present.

Fluorescent detection systems are typically sensitive to variations in the micro array location on the chip plate and within the well. To detect the arrays that are not nearly in an exact location, fluorescents may be hard to detect and error may be generated.

It would therefore be desirable to provide an automated plate-reading device that overcomes the drawbacks mentioned above.

### BACKGROUND OF THE INVENTION

It is therefore one object of the invention to provide a plate reader having an improved optical configuration for reducing errors in the detection within the arrays.

In one aspect of the invention, a plate holder holds a plate having a first side and a second side. The plate may be a well plate or a micro-titer plate having one array or various numbers of arrays thereon. An excitation source is positioned on the first side of the plate under said plate holder. The laser source generates an excitation beam through the plate. The excitation beam forms an imaging beam at the second side of the plate. An optical assembly is positioned on the second side of the plate and receives the imaging beam. A detector is disposed adjacent to the optical assembly on the second side of the plate and receives the imaging beam and forms an image of the plate and therefore any excited array portions therein.

In a further aspect of the invention, the laser source may be positioned on an optical axis orthogonal to the surface of the plate. The detector and optical assembly may also be positioned on the optical axis. This allows the illumination of the array without shadowing effects from the sidewalls of the wells.

In another aspect of the invention, a method for analyzing a plate comprises the steps of disposing a plate and an array thereon between an excitation source and a detection source; directing an imaging beam to the detection source through an optical assembly; and, forming an image of said array at the detection source.

One feature of the invention may include a mask positioned within the optical assembly. The mask is an opaque mask used to block the excitation source from the detector. Providing a mask advantageously increases the signal-to-noise ratio of the image signal.

Another feature of another embodiment of the invention is that a surface of one of the devices in the optical assembly adjacent to the plate such as the long pass filter may have a surface parallel to the well plate. By aligning the optical assembly along an axis orthogonal to the well plate (and thus the forward surface of the long pass filter), the amount of excitation radiation is advantageously increased at the array. That is, laser light passing through the well plate has a portion of which that reflects from the surface of the long pass filter back down through the well plate at the well portion. By directly reflecting back through the plate, the portions of the plate not defining a well are also not illuminated while the amount of excitation illumination at the array is increased.

Other objects, features and advantages of the invention will become apparent when viewed in light of the detailed description of the preferred embodiment when taken in conjunction with the attached drawings and appended claims.

### BRIEF DESCRIPTION OF THE DRAWINGS

FIG. 1 is a perspective view of an analysis device according to the present invention.

FIG. 2 is a top view of an analytical chip plate for use with the present invention.

FIG. 3 is a cross-sectional view of an analytical chip plate according to the present invention.

FIG. 4 is a side view of the analysis device according to the present invention.

FIG. 5 is a block diagrammatic/layout view of the analysis device according to the present invention.

FIG. 6 is a photograph of an image of a well plate not using a mask.

FIG. 7 is a plot of CCD counts versus pixel number of the output of the CCD not using an opaque mask.

FIG. 8 is a picture of the output of a detector according to the present invention using a mask.

FIG. 9 is a plot of CCD counts versus pixel number of a plot of the output of the CCD using an opaque mask.

FIG. 10 is a plot of the output of a detector according to the present invention.

FIG. 11 is a plot of the output of a CCD versus pixel number illustrated along the line C-C of FIG. 10.

FIGS. 12 is a calibration plate used to calibrate the present invention.

FIG. 13 is an alternative view of an analysis system according to the present invention.

### DETAILED DESCRIPTION

In the following figures, the same reference numerals will be used to identify identical components. The present invention is described with respect to an analytical chip plate. The analytical chip plate is defined as a micro-titer plate, a well plate, a PCR plate or other plates used for various types of analysis. The plate may also comprise a multi-layer micro fluidic device.

Referring now to FIG. 1, an analysis device 10 according to the present invention is illustrated. Analysis device 10 may be part of an automated system for analyzing and processing plates. Various robots and other types of heating, cooling and processing devices may be incorporated into a system. Analysis device 10 has a base portion 12 to which various components for performing analysis are mounted. A cover 14 may also be used to prevent environmental interference with the analytical device during processing.

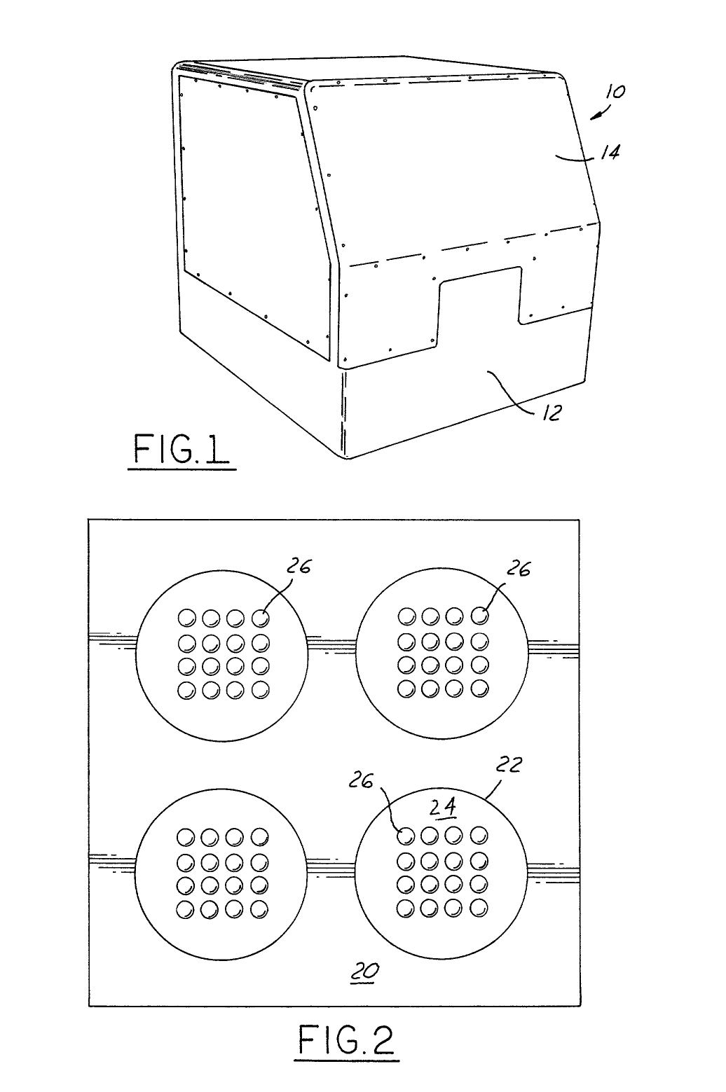

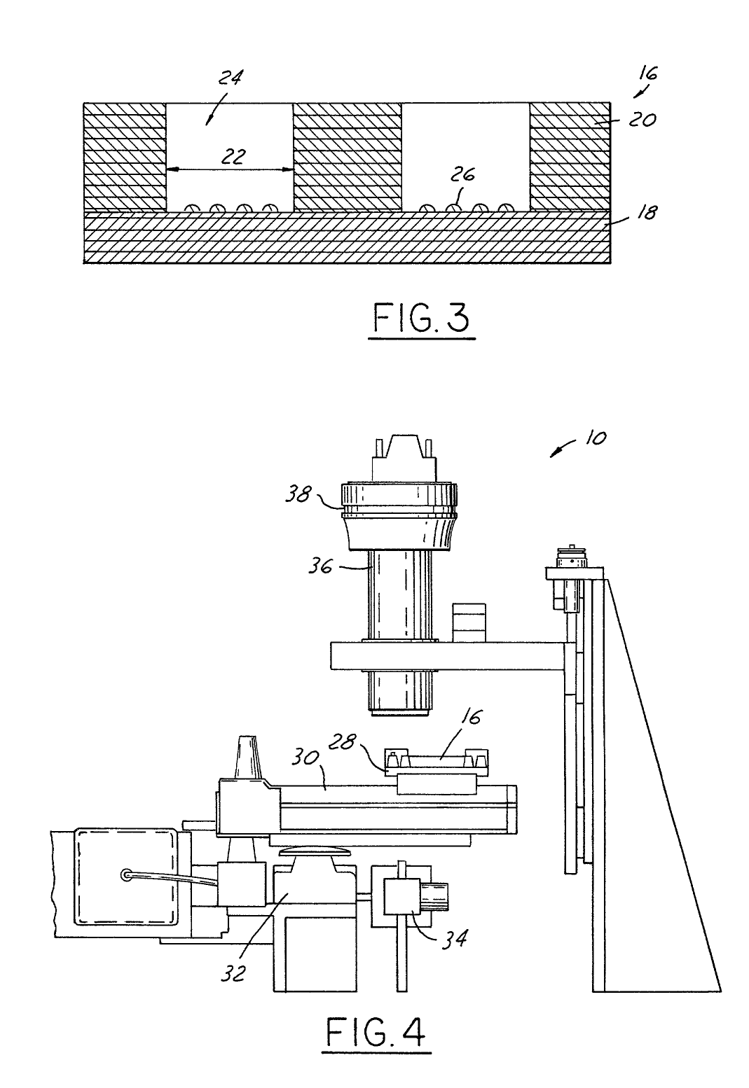

Referring now to FIGS. 2 and 3, a portion of an analytical chip plate 16 is illustrated. Chip plate 16, in this example, is formed from a micro-array support 18 having a well former 20 thereon. Well former 20 has a plurality of openings 22 therethrough. Openings 22 define a well 24 therein. Wells 24 have an array 26 of material positioned therein. Array 26 may, for example, contain genetic material such as DNA or single nucleotide polymorphisms. The array material 26 may also be referred to as a probe. The array material emits a wavelength of light different than the excitation source in the presence of the excitation source. In the constructed embodiment, the array material 26 preferably fluoresces to indicate the presence or absence of a material to be detected by the analysis device 10. Although the array 26 is illustrated with four rows and four columns, various numbers of array spots may be used. Likewise, openings 22 are illustrated as circular openings. Those skilled in the art will recognize that various size openings may also be used.

Micro array support 18 is preferably formed of a transparent or semi-transparent material such as glass or plastic. The glass may be treated to promote bonding of the array 26 with the glass. Various types sizes of micro array support 18 may be used.

Well former 20 is preferably formed of a non-fluorescing material such as blackened foam such as neoprene. Such material is also preferably light absorbing.

Referring now to FIG. 4, a side view of one constructed embodiment of analysis device 10 is illustrated. Chip plate 16 of FIGS. 2 and 3 above is held by a chip plate holder 28. Chip plate holder 28 is coupled to an X-Y stage 30 used to position chip plate 28 within analysis device 10. X-Y stage 30 maintains chip plate holder 28 on a plate and translates the chip plate in the X-Y plane. X-Y stage 30 may, for example, be comprised of a series of high precision motors such as stepper motors for positioning chip plate holder 28.

An excitation source 32 such as a laser is used to generate an excitation beam. Excitation source 32 may be coupled to excitation optics 34 for directing the excitation beam. Excitation optics 34 may include a randomizer to evenly distribute the laser light across a desired width. In the constructed embodiment, excitation source 32 is formed from a 488 manometer wavelength laser. Of course, other wavelength lasers may be used depending on the materials of the micro array support 18, the material of well former 20 and the type of detection that device 10 is used for.

Excitation source 32 and excitation optics 34 is positioned on a first side of chip plate holder 28. As illustrated, excitation source 32 and excitation optics 34 are located beneath chip plate holder 28.

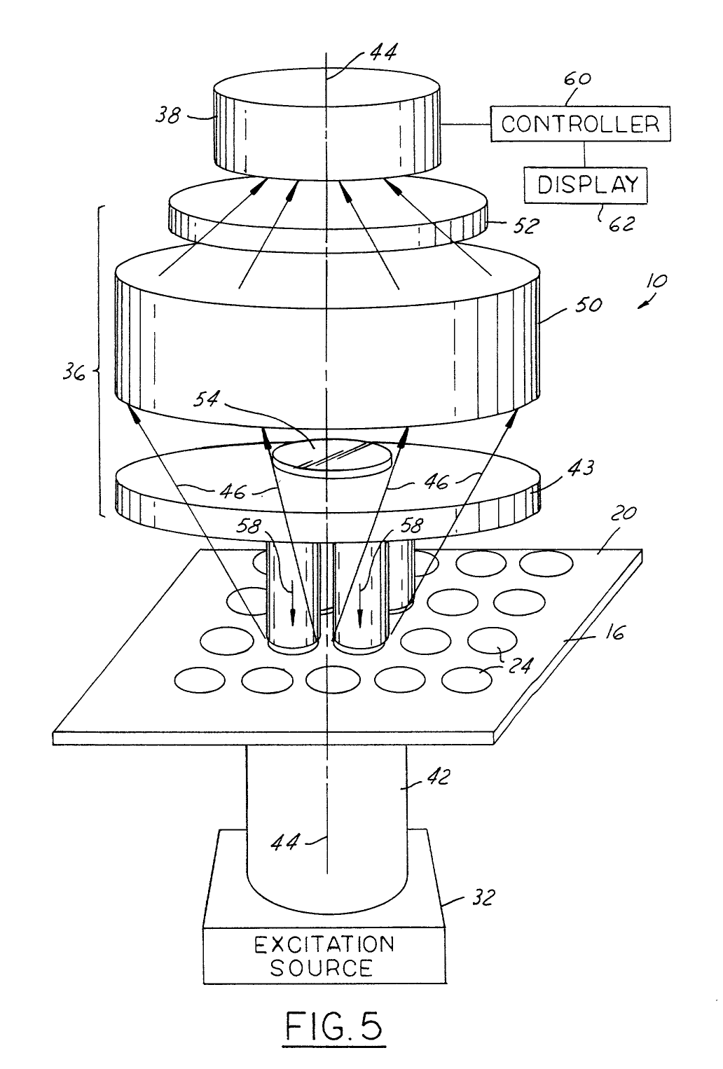

An optical assembly 36 is positioned on a second side or above chip plate holder 28. Optical assembly 36 directs the light from chip plate 16 to form an image at a detector 38. Optics 36 will be further described below in FIG. 5.

Detector 38 may be formed of a two-dimensional photo-sensor, for example, a charge couple device (CCD). The CCD is preferably also a cooled device.

Optical assembly 36 and detector 38 are positioned within device 10 through the use of a mounting arm 40. Mounting arm 40 may be positioned in various locations and is preferably coupled to base portion 12 illustrated above in FIG. 1. Mounting arm 40 may be adjustable to allow various size devices and relative positioning of optical assembly in detector 38 thereby.

Referring now to FIG. 5, a simplified schematic view of an analysis device 10 is illustrated in further detail. Excitation source 32, which may include excitation optics 34 shown in FIG. 4, is shown generating an excitation beam 42. Excitation beam is formed having a width suitable for illuminating various number of wells. In one constructed embodiment, an area of two wells by three wells is illuminated. Excitation source 32 generates the excitation beam 42 along an optical axis 44 in the preferred embodiment. When the excitation beam passes through the plate, it may also be referred to as a signaling beam. Optical axis 44 is orthogonal to the plane of chip plate 16. The excitation beam 42 is absorbed by well former 20 and thus only areas corresponding to well 24 transmit light. The excitation beam 42 causes the micro arrays to fluoresce. The fluorescing imaging signals collected at excitation optics 34 and directed to detector 38. The fluorescing arrays 26 will be referred hereinafter as an imaging beam or beams 46. The imaging beams 46 are formed of the fluorescing light which is collected by optical assembly 36.

Optical assembly 36 is illustrated in a preferred configuration. However, those skilled in the art will recognize that various configurations of optical assembly 36 may be formed. Optical assembly 36 has a separation filter such as long pass filter 48, an imaging lens 50, and a band pass filter 52. An opaque mask 54 may also be included in optical assembly 36. Long pass filter 48 is preferably an interference long-pass filter. One example of a suitable separation filter comprises an optical filter with deep attenuation in the stop band and sharp transition from the stop band to the pass band. A suitable example is a Raman filter manufactured by Omega Optical, Inc. Preferably, long pass filter 48 has a generally planar surface 56 positioned parallel to chip plate 16 and orthogonal to optical axis 44. Long pass filter 48 transmits spectrically shifted fluorescent therethrough. Non-shifted excitation beam forms a reflected beam 58 that is directed back to wells 24. The reflected beams 58 pass through micro array support 18.

Several advantages are apparent from such a configuration. One is that the amount of power for excitation beam 42 may be reduced because some of the excitation beam is reflected to form reflected beams 58 which increases the amount of excitation at arrays 26. That is, the reflected beam 58 substantially doubles the amount of excitation available at arrays 26. Background noise is not increased because of the geometry of surface 56. The reflective beams 58 directly pass back through the wells 24 and micro array support 18. That is, the top surface of well former 20 is not illuminated and thus does not contribute to background noise reflected back to detector 38.

Imaging lens 50 collects the imaging beams 46 and directs them to detector 38. Various types and sizes of imaging lens 50 may be used. One example of a suitable imaging lens is a double-confocal lens. Imaging lens 50 forms an image of the arrays and well plate at the detector.

Opaque mask 54 may be positioned between long pass filter and imaging lens. Opaque mask 54 has a diameter corresponding to the diameter of excitation beam 42 so that it may be blocked from passing through to detector 38. Opaque mask 54 can help to reduce damage to detector 38 if an improper long pass filter 48 is placed within the system. Opaque mask 54 is, however, not a required component.

Band pass filter 52 is illustrated positioned between imaging lens 50 and detector 38. Band pass filter 52 has a transmission band centered near the maximum array emission corresponding to the fluorescing-imaging beam 46. Although band pass filter is illustrated between imaging lens 50 and detector 38, band pass filter 52 may be formed directly on the top surface of long pass filter 48 or mounted in a filter wheel positioned on mounting arm 50. The ultimate position of band pass filter will depend on the use of analysis device 10. With the long pass filter 48 and band pass filter 52, detector 38 forms an image of the chip plate 16 and preferably the fluorescing arrays 26 therein. Detector 38 may be coupled to a controller 60 which in turn is coupled to a display 62. Controller 60 and display 62 may be a conventional computer system. Controller 60 may also be used to control various other functions of analysis device 10. For example, controller 60 may select the proper band pass filter 52, if a wheel containing multiple band pass filters is used. Controller 60 also stores the image of the wells 24 which, in turn, may be used for further processing.

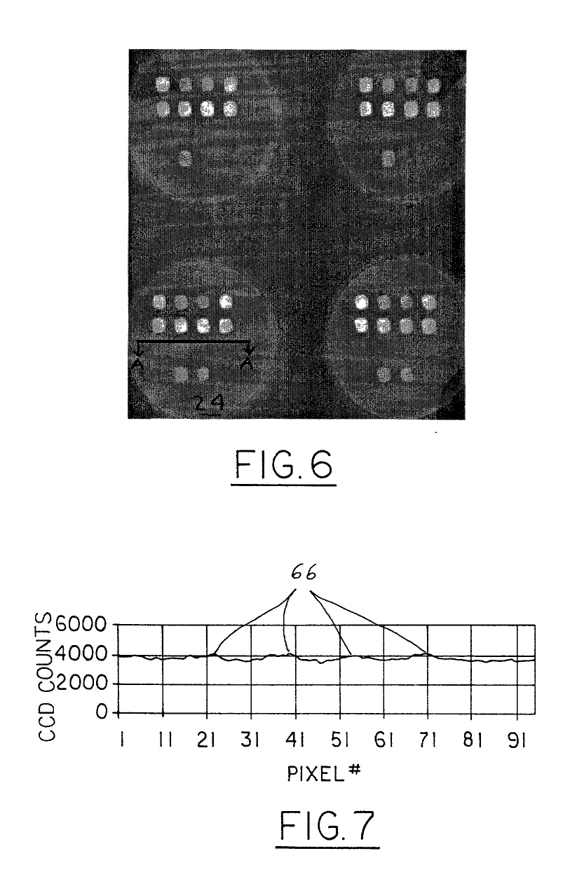

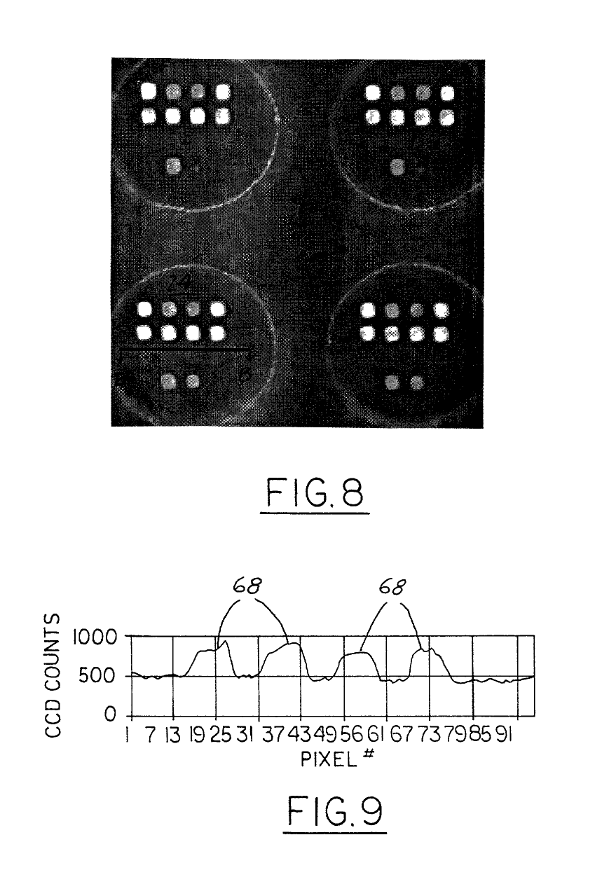

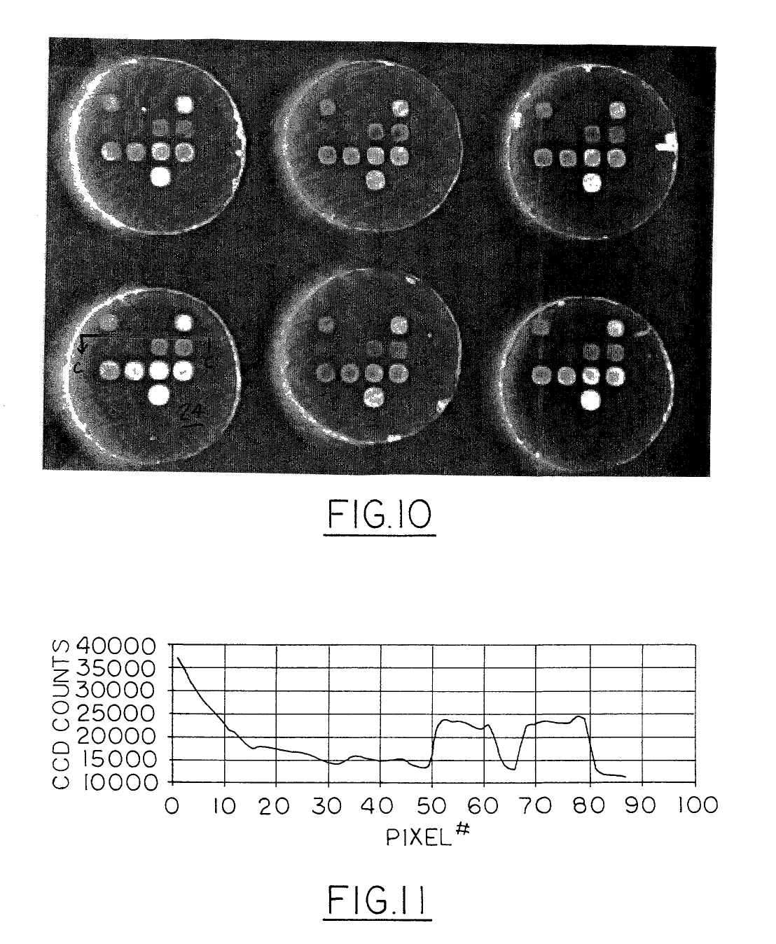

Referring now to FIGS. 6, 7, 8 and 9, by comparing the two figures, the advantage of using an opaque mask 54 illustrated in FIG. 5 is shown. In FIG. 6, an image of wells 24 without an opaque mask is shown. As can be seen in FIG. 7, very low distinction discrimination is shown for the signal taken along line A-A. Four peaks 66 in the signal of FIG. 7 are generally shown but are hard to discriminate. In FIGS. 8 and 9, when an opaque mask of 54 of FIG. 5 is used, the output of detector has four substantially defined peaks 68 when taken along line B-B. That is, the signal-to-noise ratio of the image signal has been increased.

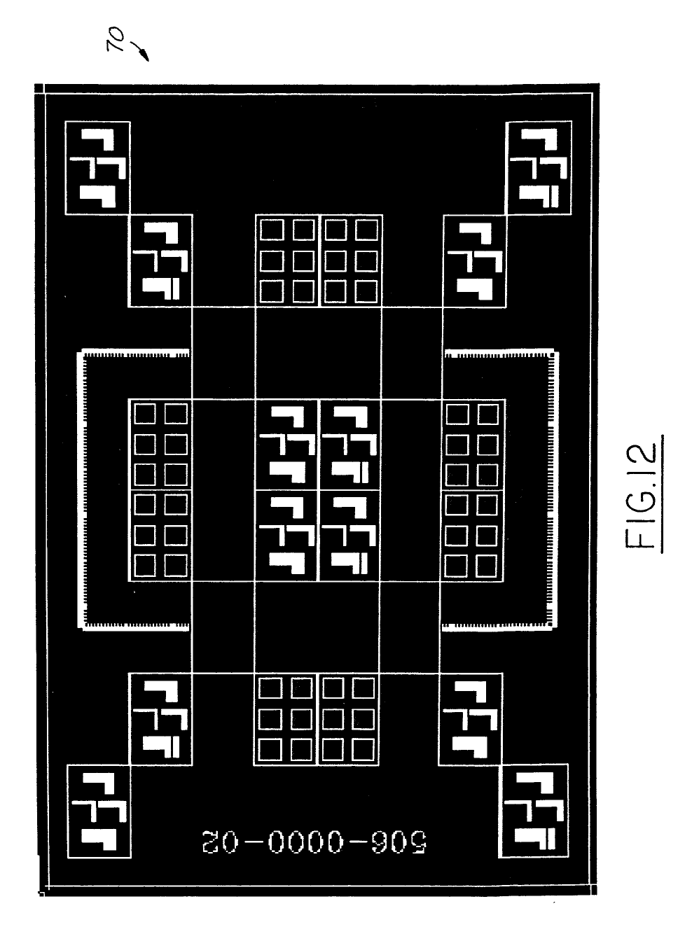

Referring now to FIGS. 10 and 11, an image of a well is illustrated in FIG. 10 along with the corresponding output of the detector in FIG. 11. The output shown in FIG. 11 is taken along line C-C of FIG. 10. As can be seen, the first two spots in FIG. 10 do not fluoresce while the second two spots show substantial fluorescence. The discrimination between fluorescing and non-fluorescing spots is the desired result of the system. By knowing which materials are placed at each spot, a suitable analysis may be performed on the image within the controller 60. The controller 60 may generate an output indicative of the presence or absence of a reaction at each of the locations within the array.

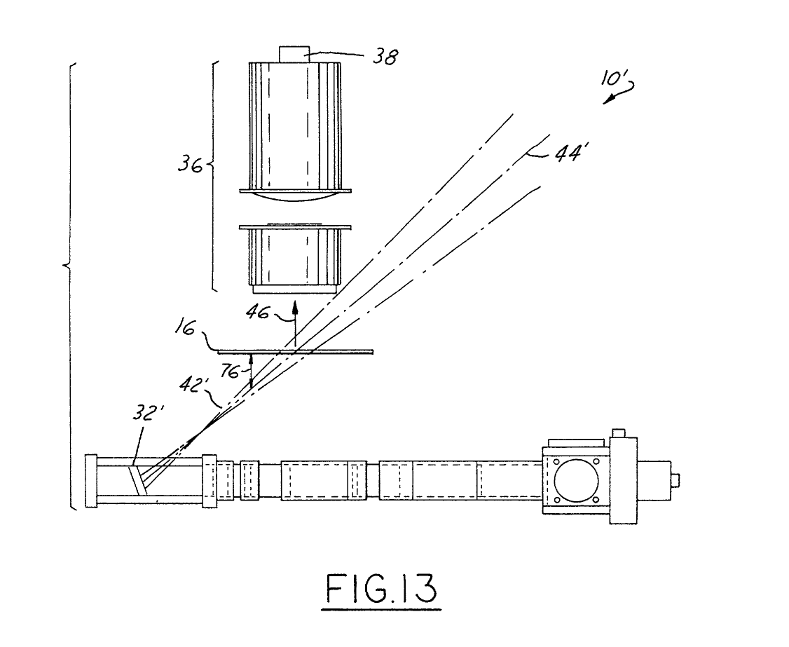

Referring now to FIG. 12, a calibration plate 70 is illustrated. Calibration plate 70 has a desired pattern that is used to calibrate detector 38 during the set up of analysis device 10. The output of detector can thus be adjusted prior to operation.

Referring now to FIG. 13, an alternative embodiment of analysis device 10′ is illustrated. Chip plate 16, optical assembly 36 and detector 38 may be configured in an identical manner to that described above with the exception that they are not aligned along the optical axis 44′. In this embodiment, excitation source 32′ generates excitation beam 42′ at an angle 76 relative to the plane of chip plate 16. Angle 76 is preferably an acute angle. In one constructed embodiment, angle 76 was about 400. In this embodiment, the excitation beam 42 does not enter detector 38 and therefore no opaque mask 54 need be included in optics 36. One drawback to this system is that by providing excitation beam 42 at an angle, the analysis device 10 may have to be increased in size compared to that shown above.

In operation, a chip plate 16 is positioned between an excitation source and a detector. An imaging beam is formed at the plate and is routed through to the detector. An image is formed at the detector. The imaging beam may be filtered by a long pass filter and a band pass filter before entering the detector. An imaging lens 50 may also be used to direct the imaging beam 46 to the detector. A mask 54 may be positioned after the long pass filter and before the detector for blocking the excitation beam 42 from entering the detector 38. As mentioned above, the surface of long pass filter 48 is orthogonal to the optical axis in the first embodiment and therefore reflects the excitation beam 42 back to the array 26.

While particular embodiments of the invention have been shown and described, numerous variations alternate embodiments will occur to those skilled in the art. Accordingly, it is intended that the invention be limited only in terms of the appended claims.

What is claimed is:

1. An analysis device for analyzing an object having a first side and a second side comprising:
an excitation source positioned on a first side of said object, said excitation source generating an excitation beam through said object; said excitation beam forming a imaging beam on the second side of said object,
an optical assembly positioned on the second side of the object receiving the imaging beam; and
a detector disposed adjacent to said optical assembly on said second side of said object receiving said imaging beam and forming an image of said object therein.

2. An analysis device for a plate having a first side and a second side comprising:
a plate holder holding the plate;
a excitation source positioned on a first side of said plate under said plate holder, said excitation source generating an excitation beam through said plate; said excitation beam forming an imaging beam on the second side of said plate,
an optical assembly positioned on the second side of the plate receiving the imaging beam; and
a detector disposed adjacent to said optical assembly on said second side of said plate receiving said imaging beam and forming an image of said plate therein.

3. An analysis device as recited in claim 2 wherein said optical assembly comprises a separation filter disposed on a second side of said plate holder receiving the imaging beam;
an imaging lens positioned adjacent to said long pass filter on said second side of said plate;
said imaging beam directed through said separation filter, said imaging lens and said band pass filter.

4. An analysis device as recited in claim 3 wherein said optical assembly comprises a band pass filter disposed adjacent to said imaging lens on said second side of said plate;
said imaging beam directed through said separation filter, said imaging lens and said band pass filter.

5. An analysis device as recited in claim 3 wherein said long pass filter has a surface parallel to said plate.

6. An analysis device as recited in claim 3 further comprising an opaque mask interposed between said separation filter and said imaging lens.

7. An analysis device as recited in claim 3 wherein said opaque mask has a diameter sized to prevent said excitation beam from reaching said detector.

8. An analysis device as recited in claim 3 wherein said long-pass filter comprises a filter having deep-attenuation in a stop-band and sharp transition from the stop-band to a pass-band.

9. An analysis device as recited in claim 8 wherein said separation filter comprises a Raman filter.

10. An analysis device as recited in claim 4 wherein said laser source has an optical axis positioned orthogonal to said plate, said detector, long pass filter, said imaging lens, and said band pass filter coupled disposed along said axis.

11. An analysis device as recited in claim 2 wherein said detector comprises a charge coupled device having a two-dimensional array of detectors.

12. An analysis device as recited in claim 2 wherein said excitation light source comprises fluorescent light source.

13. An analysis device as recited in claim 2 wherein said excitation light source comprises a laser source.

14. An analysis device as recited in claim 2 wherein said laser source has an optical axis positioned at an angle relative to said plate.

15. An analysis device as recited in claim 2 said detector positioned off said optical axis.

16. An analysis device as recited in claim 2 wherein said plate holder is coupled to an X-Y stage.

17. An analysis device as recited in claim 2 wherein said plate holder comprises a plurality of wells defined by a mask, said mask blocking said excitation light outside said wells.

18. An analysis device as recited in claim 2 wherein said plate has a light absorbing well former thereon having openings therethrough, said excitation source generating an excitation beam through said openings and plate.

19. An analysis device for a plate having a first side an second side comprising:
a plate holder holding the plate;
an excitation light source positioned on a first side of side plate under said plate holder, said laser source generating an excitation beam through said plate; said excitation beam forming an imaging beam at said plate, said excitation light source has an optical axis positioned orthogonal to said plate;
an optical assembly disposed on said optical axis on the second side;
a detector disposed adjacent to said optical assembly;
said imaging beam directed through said long-pass filter, said imaging lens and said band pass filter.

20. An analysis device as recited in claim 19 wherein said optical assembly comprises a long-pass filter and an imaging lens filter.

21. An analysis device as recited in claim 19 wherein said long-pass filter is disposed on a second side of said plate holder along the optical axis receiving the imaging beam.

22. An analysis device as recited in claim 19 wherein said imaging lens positioned adjacent to said long pass filter holder along the optical axis on said second side of said plate.

23. An analysis device as recited in claim 19 wherein said band pass filter disposed adjacent to said imaging lens holder along the optical axis on said second side of said plate.

24. An analysis device as recited in claim 19 wherein said plate has a light absorbing well former thereon.

25. A method for analyzing a plate comprising:
disposing a plate having an array thereon between an excitation source and a detection source;
directing a imaging beam to said detection source through an optical assembly; and
forming an image of said array at said detection source.

26. A method as recited in claim 23 wherein said chip plate comprises a plurality of wells defined by a mask and further comprising blocking said excitation light outside said wells with the mask.

27. A method as recited in claim 23 further comprising the step of filtering said imaging beam.

28. A method as recited in claim 23 wherein said step of filtering comprises long pass filtering said imaging beam.

29. A method as recited in claim 23 wherein said step of filtering comprises band pass filtering said imaging beam.

30. A method as recited in claim 23 wherein directing an imaging beam to said detection source through an imaging lens.

31. A method as recited in claim 23 further comprising reflecting a portion of said excitation beam from the optical assembly to said plate.
